(19) United States
(12) Patent Application Publication
(10) Pub. No.: US 2017/0004802 A1
(43) Pub. Date: Jan. 5, 2017

(54) DIGITAL SIGNAGE

(71) Applicant: ASUSTeK COMPUTER INC., Taipei City (TW)

(72) Inventors: Yu-Rung Huang, Taipei City (TW); Chia-Chiao Ho, Taipei City (TW)

(21) Appl. No.: 15/197,785

(22) Filed: Jun. 30, 2016

Related U.S. Application Data
(60) Provisional application No. 62/187,812, filed on Jul. 1, 2015.

(30) Foreign Application Priority Data
May 5, 2016 (TW) 105113915

(51) Int. Cl. G09G 5/00; G09F 7/00

(52) U.S. Cl. CPC G09G 5/003; G09F 7/00; G09G 2380/06; G09G 2370/16; G09G 2354/00

(57) ABSTRACT

A digital signage is provided. The digital signage includes a display unit, a first circuit board and a second circuit board. The second circuit board is detachably connected to the first circuit board. The second circuit board executes an operation system to provide a first display signal to the first circuit board. The first circuit board controls the display unit to display according to the first display signal.

### CROSS-REFERENCE TO RELATED APPLICATION

This application claims the priority benefit of U.S. provisional application Ser. No. 62/187,812, filed on Jul. 1, 2015 and Taiwan application serial No. 105113915, filed on May 5, 2016. The entirety of each of the above-mentioned patent applications is hereby incorporated by references herein and made a part of specification.

### BACKGROUND OF THE INVENTION

Field of the Invention

The invention relates to a display device and, more specifically, to a digital signage.

Description of the Related Art

With the development of the multimedia technology, a digital signage can be disposed in a public place to provide information to the people there. In order to make the digital signage show more information to the public effectively, the digital signage usually has a large size and is usually disposed at a high position. Moreover, to avoid affecting the pedestrians, the digital signage is usually disposed against a pillar or a wall.

### BRIEF SUMMARY OF THE INVENTION

A digital signage includes a display unit, a first circuit board and a second circuit board. The first circuit board is coupled to the display unit to control the display unit to display. The second circuit board is detachably connected to the first circuit board and configured to execute an operation system. The second circuit board is configured to provide a first display signal to the first circuit board to make the first circuit board control the display unit to display according to the first display signal.

In sum, instead of securing the whole circuit board in the digital signage, the second circuit board in the disclosure is configured to be replaced easily, and the repair cost of the digital signage is reduced significantly.

### BRIEF DESCRIPTION OF THE DRAWINGS

These and other features, aspects and advantages of the invention will become better understood with regard to the following embodiments and accompanying drawings.

FIG. 1 is a schematic view of a digital signage according to an embodiment.

FIG. 2 is a schematic view of a second circuit board according to an embodiment.

FIG. 3 is a schematic view of a digital signage according to an embodiment.

FIG. 4 is a schematic view of a back surface of a digital signage according to an embodiment.

FIG. 5 is a schematic view of assembling a second circuit board according to an embodiment.

### DETAILED DESCRIPTION OF THE EMBODIMENTS

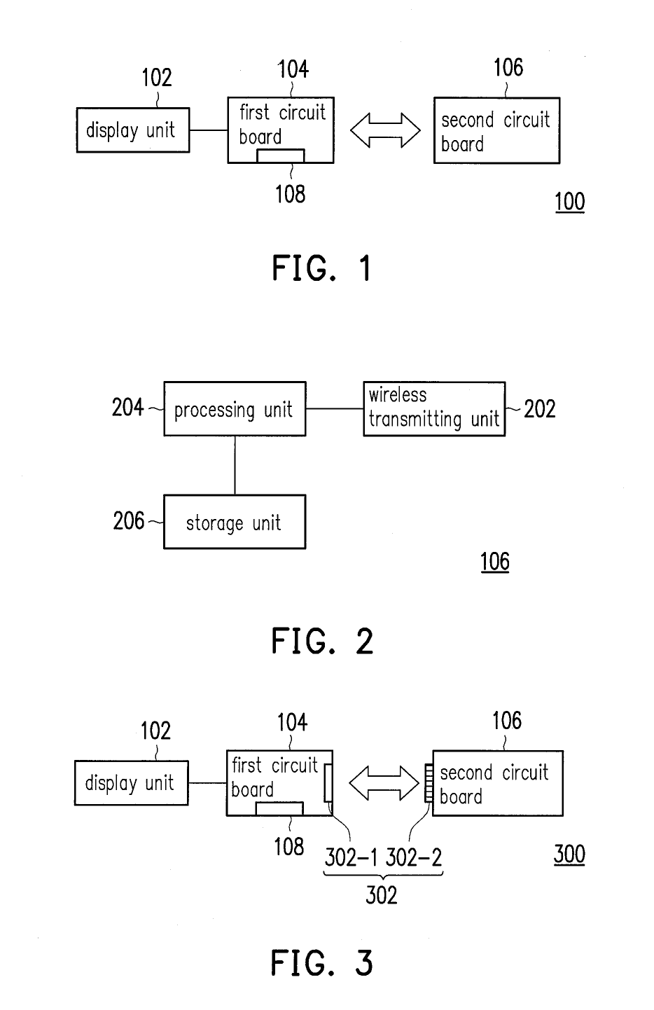

FIG. 1 is a schematic view of the digital signage according to an embodiment. Please refer to FIG. 1, in an embodiment, the digital signage 100 includes a display unit 102, a first circuit board 104 and a second circuit board 106. The first circuit board 104 is connected to the display unit 102. The second circuit board 106 is detachably connected to the first circuit board 104.

The first circuit board 104 is configured to control the display unit 102 to display images, and the second circuit board 106 is configured to execute an operation system, and provide a display signal to the first circuit board 104, to make the first circuit board 104 control the display unit 102 to display the corresponding image according to the display signal.

In an embodiment, the first circuit board 104 is a circuit board used to control the display unit 102 to display, and the second circuit board 106 is a system circuit board designed for different functions according to the practical requirement, which is not limited herein. In an embodiment, the second circuit board 106 is a system circuit board used for a multimedia play device, or a point of sale (POS) device. With the system circuit board configured to different functions is applied in the digital signage 100, the digital signage 100 provides different functions according to the equipped system circuit board, such as a multimedia play device, a point of sale device and so on, which is not limited herein.

The second circuit board 106 shown in FIG. 2 includes a wireless transmitting unit 202, a processing unit 204 and a storage unit 206. The processing unit 204 is coupled to the wireless transmitting unit 202 and the storage unit 206.

The storage unit 206 stores the operation system and the display data. The operation system is different according to the function of the second circuit board 106, such as an Android operation system, a point of sale (POS) operation system and so on, which is not limited herein.

The processing unit 204 is used to execute an operation system of the storage unit 206. Moreover, the processing unit 204 receives at least one of an operation command and display data from other communication devices via the wireless transmitting unit 202 to execute an operation corresponding to the operation command, such as setting screen parameters and executing applications of the digital signage 100.

The processing unit 204 outputs the display signal according to the display data to the first circuit board 104, and then the first circuit board 104 controls the display unit 102 to display images according to the display signal. Consequently, the digital signage 100 is controlled remotely according to the operation command and the display data received from other communication devices via the wireless transmitting unit 202. In other words, the user can just input operation command via his communication device and wirelessly controls the digital signage 100 displaying images, which is very convenient. In an embodiment, the display unit 102 is a touch panel display, the processing unit 204 executes a corresponding operation according to a touch gesture of the user.

Since the second circuit board 106 is detachably connected to the first circuit board 104, when the second circuit board 106 goes wrong, the second circuit board 106 can be replaced easily. Comparing with the conventional method of securing the whole circuit board in the digital signage of which the whole circuit board needs to be detached for repairs, the repair cost of the digital signage 100 in the embodiment is reduced significantly.

In an embodiment, the first circuit board 104 includes a signal transmission port 108. The first circuit board 104 is connected to another electronic device, such as a computer, a video playing device, to receive the display signal via the signal transmission port 108. Then, the display unit 102 is controlled to display according to the display signal from the signal transmission port 108. Consequently, when the first circuit board 104 is not connected to the second circuit board, the digital signage 100 still receives the display signal via the signal transmission port 108 from the connected electronic devices.

In an embodiment, the signal transmission port 108 is a High Definition Multimedia Interface (HDMI) port, or a Video Graphics Array (VGA) port, which is not limited herein. Moreover, in other embodiments, the first circuit board 104 includes multiple signal transmission ports having the same or different transmission interface.

FIG. 3 is a schematic view of a digital signage according to an embodiment. Please refer to FIG. 3, in an embodiment, comparing with the digital signage 100, the digital signage 300 includes a connector 302, the second circuit board 106 is detachably connected to the first circuit board 104 via the connector 302.

In an embodiment, the connector 302 is a Peripheral Component Interconnect Express (PCIE) connector. The connector 302 includes a PCIE slot 302-1 and a PCIE pin 302-2. The PCIE slot 302-1 and the PCIE pin 302-2 are disposed on the first circuit board 104 and the second circuit board 106 respectively, and the first circuit board 104 and the second circuit board 106 are connected by connecting the PCIE slot 302-1 with the PCIE pin 302-2.

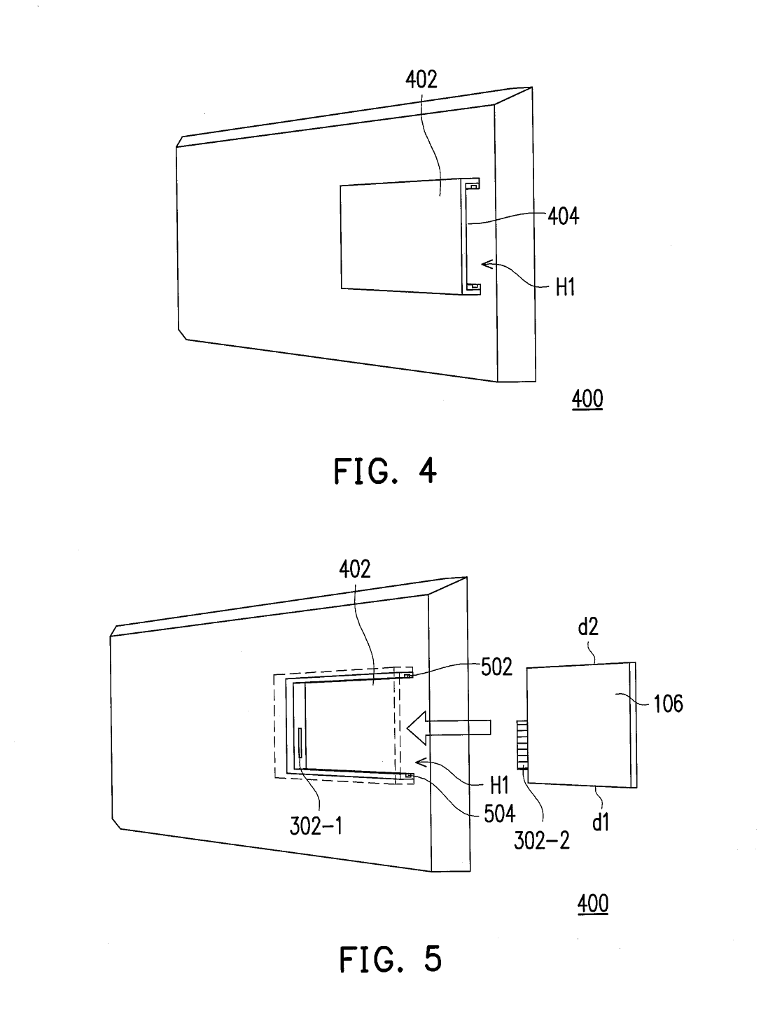

FIG. 4 is a schematic view of a back surface of the digital signage according to an embodiment. Please refer to FIG. 4, the digital signage 400 includes a casing 402. The casing 402 includes an accommodating space 404 and an opening H1, the opening H1 is communicated with the accommodating space 404. The accommodating space 404 is used for accommodating the second circuit board 106, and the second circuit board 106 is disposed in the accommodating space 404 via the opening H1.

FIG. 5 is a schematic view of assembling the second circuit board according to an embodiment. Please refer to FIG. 5, a first runner 502 and a second runner 504 arranged in opposite side are configured in the accommodating space 404 of the digital signage 400, the extension direction of the first runner 502 and the second runner 504 is same to the connecting direction between the second circuit board 102 and the first circuit board 104. The second circuit board 106 includes a first side edge d1 and a second side edge d2 opposite to each other. The first side edge d1 and the second side edge d2 are disposed in the first runner 502 and the second runner 502 respectively for the second circuit board 106 to slide along the first runner 502 and the second runner 504 to connect with the first circuit board 104.

As a result, the second circuit board 106 can be detached conveniently, instead of detaching the whole digital signage to replace the circuit board in the digital signage as in the conventional method. In an embodiment, the second circuit board 106 is inserted into or pulled out from the digital signage 400 via the opening H1 without detaching the whole body of the digital signage 400. Then, to repair the digital signage 400 is easy and the repair cost of the digital signage 400 is reduced.

In an embodiment, the first circuit board 104 is detachably connected to the display unit 102, the connection manner is similar to the connection between the first circuit board 104 and the second circuit board 106, which is not limited herein.

In sum, the second circuit board is detachably connected to the first circuit board, when the digital signage has an equipment failure, the second circuit board can be replaced directly without detaching the whole circuit board, and thus the repair cost is reduced. In an embodiment, the second circuit board is inserted into or pulled out from the digital signage via the opening of the casing of the digital signage, the repair of the digital signage is more convenient, and the repair cost is further reduced.

Although the invention has been disclosed with reference to certain embodiments thereof, the disclosure is not for limiting the scope. Persons having ordinary skill in the art may make various modifications and changes without departing from the scope of the invention. Therefore, the scope of the appended claims should not be limited to the description of the embodiments described above.

What is claimed is:

1. A digital signage, comprising:
a display unit;
a first circuit board coupled to the display unit and configured to control the display unit to display;
a second circuit board detachably connected to the first circuit board and configured to execute an operation system to provide a first display signal to the first circuit board to control the display unit according to the first display signal.

2. The digital signage of claim 1, further comprising:
a connector, detachably connects the second circuit board and the first circuit board.

3. The digital signage of claim 2, wherein the connector is a Peripheral Component Interconnect Express (PCIE) connector.

4. The digital signage of claim 1, wherein the first circuit board further comprises:
a signal transmission port, the first circuit board receives a second display signal via the signal transmission port, and controls the display unit according to the second display signal.

5. The digital signage of claim 1, further comprising:
a casing including an accommodating space and an opening, wherein the opening is communicated through the accommodating space, and a first runner and a second runner are configured in the accommodating space for the second circuit board to slide along.

6. The digital signage of claim 1, wherein the second circuit board further comprises:
a wireless transmitting unit;
a processing unit coupled to the wireless transmitting unit and executing the operation system, the processing unit receives at least one of an operation command and display data via the wireless transmitting unit to execute an operation corresponding to the operation command, and outputs the first display signal to the first circuit board according to the display data; and
a storage unit coupled to the processing unit, and storing the operation system and the display data.

7. The digital signage of claim 1, wherein the first circuit board is detachably connected to the display unit.
